(19) United States
(12) Patent Application Publication
(10) Pub. No.: US 2015/0046935 A1
(43) Pub. Date: Feb. 12, 2015

(54) Guaranteed Ad Targeting with Stable Precision

(71) Applicant: Hulu, LLC, Santa Monica, CA (US)

(72) Inventors: Xuan Wei, Beijing (CN); Dong Guo, Beijing (CN); Hua Zheng, Beijing (CN); Joyce Zhang, Beijing (CN)

(21) Appl. No.: 14/080,672

(22) Filed: Nov. 14, 2013

Related U.S. Application Data
(63) Continuation of application No. PCT/CN2013/080876, filed on Aug. 6, 2013.

(51) Int. Cl. G06Q 30/02; H04N 21/442; H04N 21/24; H04N 21/81

(52) U.S. Cl. CPC G06Q 30/0251; H04N 21/812; H04N 21/44213; H04N 21/24
USPC 725/14

(57) ABSTRACT

In one embodiment, a method trains a predictive model configured to predict a probability that advertisement (ad) impressions belong to a segment that is being targeted where the ad impressions are provided during sending of videos to users. A first threshold is determined in which the probability predicted from the predictive model is compared to determine whether ad impressions belong to the segment. A distribution probability used in the training of the predictive model is determined. The distribution probability is determined based on a characteristic for ad impressions on a site. Then, a changed distribution probability for the site is determined. The method further determines a second threshold in which the probability predicted from the predictive model is compared to determine whether ad impressions belong to the segment.

### CROSS-REFERENCE TO RELATED APPLICATIONS

This application is a continuation of International Application No. PCT/CN2013/080876 filed Aug. 6, 2013, which is incorporated by reference in its entirety for all purposes.

### BACKGROUND

Advertising-supported distribution of audio-video data may be implemented from a content server to remote client devices over computer networks, telecommunications networks, and combinations of such networks, using various methods, such as progressive downloading or streaming. Platforms for such distribution may include sites that offer a great variety of different programming, including both newly released episodes of serial programs, major features, documentaries, special events, archives of past episodes and classic serial programs, targeted to users having various different demographic profiles. One or more video ads may be inserted into each video program and sold to advertisers who are charged based on how many times each advertisement is played on a client device; i.e., for each video ad impression.

In one example, a site may offer guaranteed ad targeting. When an advertiser purchases a video ad with guaranteed ad targeting, the advertiser is only charged when an ad impression to a targeted audience is determined to occur. For example, the advertiser may specify that the advertisement must be viewed by a female viewer between the ages of 18 and 34. The site attempts to only deliver the ad to the users that are female between the ages of 18 and 34. However, the site may not know the exact genders and ages of anonymous users, and registered users could provide wrong profiles or not enough information. Most of the time, the site can calculate the probability that the ad impression is from a female between ages of 18 and 34. For example, the site may deliver 100 Ad impressions with 80% probability that the ads belong to a female between the ages of 18 and 34, and 100 Ad impressions with 90% probability that the ads belong to a female between the ages of 18 and 34. Assuming the 80% and 90% probabilities are correct, the site will charge for 170 (100*80%+100*90%=170) ad impressions.

### SUMMARY

In one embodiment, a method trains a predictive model configured to predict a probability that advertisement (ad) impressions belong to a segment that is being targeted where the ad impressions are provided during sending of videos to users. A first threshold is determined in which the probability predicted from the predictive model is compared to determine whether ad impressions belong to the segment. A distribution probability used in the training of the predictive model is determined. The distribution probability is determined based on a characteristic for ad impressions on a site. Then, a changed distribution probability for the site is determined. The method further determines a second threshold in which the probability predicted from the predictive model is compared to determine whether ad impressions belong to the segment.

In one embodiment, a non-transitory computer-readable storage medium contains instructions, that when executed, control a computer system to be configured for: training a predictive model configured to predict a probability that advertisement (ad) impressions belong to a segment that is being targeted, the ad impressions provided during sending of videos to users; determining a first threshold in which the probability predicted from the predictive model is compared to determine whether ad impressions belong to the segment; determining a distribution probability used in the training of the predictive model, the distribution probability being determined based on a characteristic for ad impressions on a site; determining a changed distribution probability for the site; and determining a second threshold in which the probability predicted from the predictive model is compared to determine whether ad impressions belong to the segment.

In one embodiment, an apparatus includes: one or more computer processors; and a non-transitory computer-readable storage medium comprising instructions, that when executed, control the one or more computer processors to be configured for: training a predictive model configured to predict a probability that advertisement (ad) impressions belong to a segment that is being targeted, the ad impressions provided during sending of videos to users; determining a first threshold in which the probability predicted from the predictive model is compared to determine whether ad impressions belong to the segment; determining a distribution probability used in the training of the predictive model, the distribution probability being determined based on a characteristic for ad impressions on a site; determining a changed distribution probability for the site; and determining a second threshold in which the probability predicted from the predictive model is compared to determine whether ad impressions belong to the segment.

The following detailed description and accompanying drawings provide a better understanding of the nature and advantages of particular embodiments.

### BRIEF DESCRIPTION OF THE DRAWINGS

FIG. 1 depicts a simplified system for ad targeting according to one embodiment.

FIG. 2 depicts a simplified flowchart of a method for determining if an ad is targeted according to one embodiment.

FIG. 3 depicts a simplified flowchart of a method for adjusting the threshold according to one embodiment.

FIG. 4 depicts a more detailed example of an ad targeting manager according to one embodiment.

FIG. 5 depicts a graph showing the changes in the threshold according to one embodiment.

FIG. 6 depicts a video streaming system in communication with multiple client devices via one or more communication networks according to one embodiment.

FIG. 7 depicts a diagrammatic view of an apparatus for viewing video content and advertisements.

### DETAILED DESCRIPTION

Described herein are techniques for an ad targeting system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

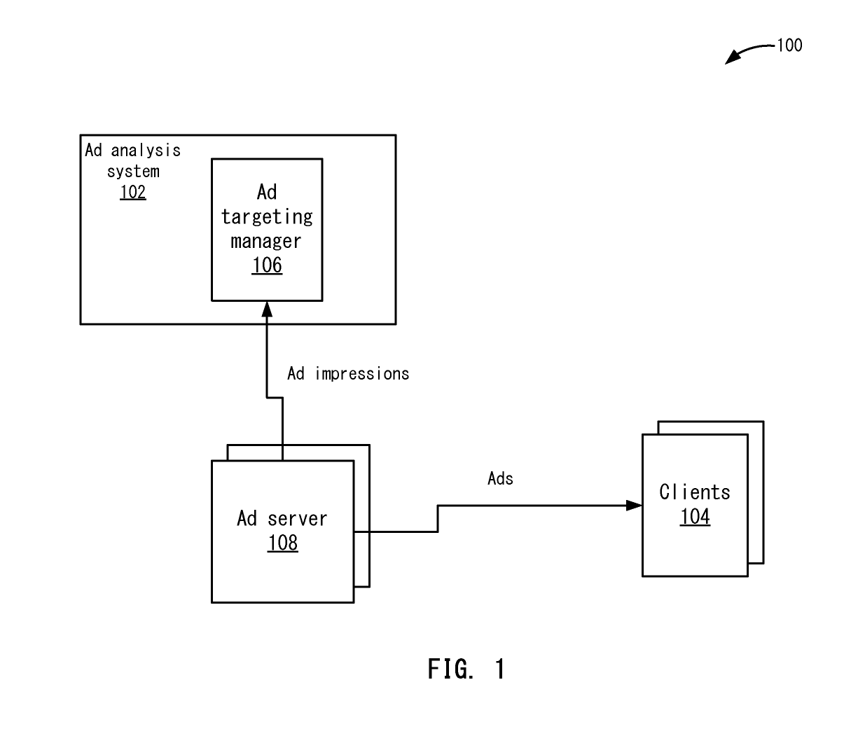

FIG. 1 depicts a simplified system 100 for ad targeting according to one embodiment. An ad analysis system 102 may analyze ad impressions for advertisements that are sent to clients 104 by an ad server 108 while videos are being sent to clients 104. For example, a site offers a variety of videos to users. During those videos, ad slots for sending ads for users to view are provided. An example of a video transmission system will be described in more detail below.

In one example, ad analysis system 102 may determine when ad impressions occur. Also, in some cases, ad analysis system 102 may determine whether to charge advertisers for these ad impressions. However, in other cases, a third party may track the ad impressions and determine whether to charge advertisers. An ad impression may be when a specific advertisement is sent to a client 104 by ad server 108 and viewed by a user (e.g., before, during, or after a user is watching a video). An ad targeting manager 106 analyzes the ad impressions and determines if the ads are targeted to a segment (e.g., females between the ages of 18 and 34). For example, as described above, some advertisers may purchase guaranteed ad targeting advertisements. In this case, ad targeting manager 106 only charges an advertiser for an ad impression when it is determined an ad impression falls within the segment. For example, if the advertiser purchases an ad impression for a female between the ages of 18 and 34, when ad targeting manager 106 determines the ad impression was viewed by a female between the ages of 18 and 34, then ad targeting manager 106 may charge the advertiser for the ad impression. However, when ad targeting manager 106 determines the ad impression was not viewed by a female between the ages of 18 and 34, then ad targeting manager 106 does not charge the advertiser for the ad impression.

In ad targeting, ad targeting manager 106 may not be able to test whether ad impressions fall within the segment directly. For example, ad targeting manager 106 may not know the exact details of users who are viewing the ad impressions, such as ad targeting manager 106 may not know whether a user viewing an ad impression is male or female, or know the age of the user. In this case, the user watching the video may be an “anonymous” user, which is a user that has not registered with the site. Also, the user may have registered with the site, but not provided a sufficient amount of information for ad targeting manager 106 to determine if the user falls within the feature group, such as ad targeting manager 106 may know the user is a female, but not the user's age. However, ad targeting manager 106 may know other features for the user, such as the user previously watched a show Family Guy, or watched a show Glee.

To determine whether the user falls within the segment, ad targeting manager 106 may use a predictive model to determine a probability that an ad impression falls within the segment desired by the advertiser. For example, the predictive model may determine that there is an 80% probability that the user is a female between the ages of 18 and 34 based on analyzing features known about the user. Ad targeting manager 106 manager uses that probability to determine whether the ad impression is targeted or not. For example, ad targeting manager 106 may use a threshold, such as 70%, to determine whether the ad impression is targeted or not. In this case, the probability is greater than the threshold (80%>70%) indicating that it is more likely than the threshold that the user in within the segment, and ad targeting manager 106 determines the ad impression is targeted.

The site providing the videos may offer an ad targeting product that keeps the targeting precision stable. That is, the precision for each segment remains stable when various conditions change. For example, if the site expects 80 ad impressions out of 100 are from a female between the ages of 18 and 34, then after various conditions change, when the site delivers 100 ad impressions, 80 of them are still from a female between ages of 18 and 34. One example of when conditions change are when a run-of-site (ROS) distribution changes (e.g., ROS changes every day for the site). The run-of-site distribution may be based on the ad impressions across all the videos offered by the site. Although all videos are described, the ROS distribution may be across a subset, such as in certain genres (comedies, action, etc.).

One example of when the ROS distribution changes may be during specific holidays for a characteristic being measured. For example, a male ROS probability rises while a female ROS probability drops during the holidays. This may be observed based on previous studies of behavior during the holidays, using third party studies or by analyzing the registered users that use the site in the past, such as the past couple of hours during the holiday. If the change in ROS probability is not taken into account, then the precision of male targeting increases while the precision of female targeting decreases. That is, the targeting for males increases because more males are watching videos; however, the targeting for females decreases because fewer females are watching videos. The precision increases for males and the precision decreases for females in response. For example, if more males are viewing videos, then it is more likely that an ad impression targeted to a male will be targeted, which increases the precision for males. However, the site may have offered an ad targeting product that guarantees that targeting precisions are stable. That is, an advertiser may not want the precision of male targeting to increase and the precision of female targeting to decrease. Rather, the advertiser may want the targeting precisions to remain stable (and the site may also). Accordingly, ad targeting manager 106 may adjust parameters, such as thresholds, that are used in the predictive modeling to determine if an ad impression belongs to a specific segment based on ROS distribution changes. The adjusting is designed to keep the targeting precision stable.

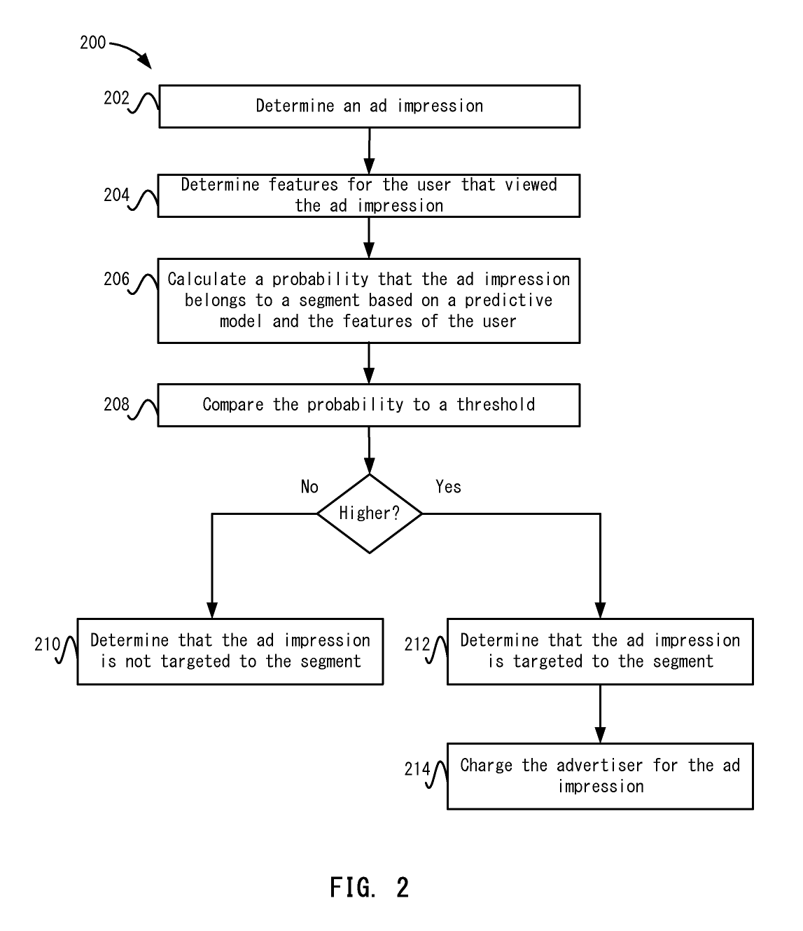

Before discussing the change in parameters, the determination of whether an ad impression should be determined as a targeted ad will be discussed. FIG. 2 depicts a simplified flowchart 200 of a method for determining if an ad is targeted according to one embodiment. At 202, ad targeting manager 106 determines an ad impression. For example, ad targeting manager 106 may track ad impressions based on ad server 108 sending ads to clients 104 while users watch videos.

At 204, ad targeting manager 106 determines features for the user that viewed the ad impression. The features that ad targeting manager 106 determines may be extracted from various information sources, such as the user's profile, behaviors, or other information. In one embodiment, the features may not include the features in the segment. For example, if the segment is females between the ages of 18 and 34, the known features may not include the age or sex of the user. In other examples, only some of the features in the segment are known, such as the user is female, but the age is not known. However, the features may include other features, such as a feature may indicate that the user watched a show called Glee.

At 206, ad targeting manger 106 calculates a probability that the ad impression belongs to a segment based on a predictive model and the features of the user. The probability may be the probability that the ad impression belongs to the segment. For example, the probability may be 60% that the ad impression belongs to the segment.

At 208, ad targeting manager 106 compares the probability to a threshold. The threshold may be set such that a certain precision of ad targeting is maintained. For example, if the threshold is 70%, ad targeting manager 106 compares the probability to the threshold. In this case, ad targeting manager 106 compares a probability of 60% to the threshold of 70%. This means that the probability that the user belongs to the segment is below the threshold. In one example, if the probability is below the threshold, then at 210, ad targeting manager 106 determines that the ad impression is not targeted to the segment. However, if the probability is above the threshold, such as the probability was 80%, at 212, ad targeting manager 106 determines that the ad impression is targeted to the segment. At 214, ad targeting manager 106 then charges the advertiser for the ad impression. When the ad is determined to be not targeted to the segment, then the advertiser may not be charged for the ad impression. In other examples, the advertiser may be charged based on the ad being non-targeted, such as a lesser amount for a non-targeted ad is charged than if the ad was targeted. Accordingly, different levels of charging exist for targeted and non-targeted ads.

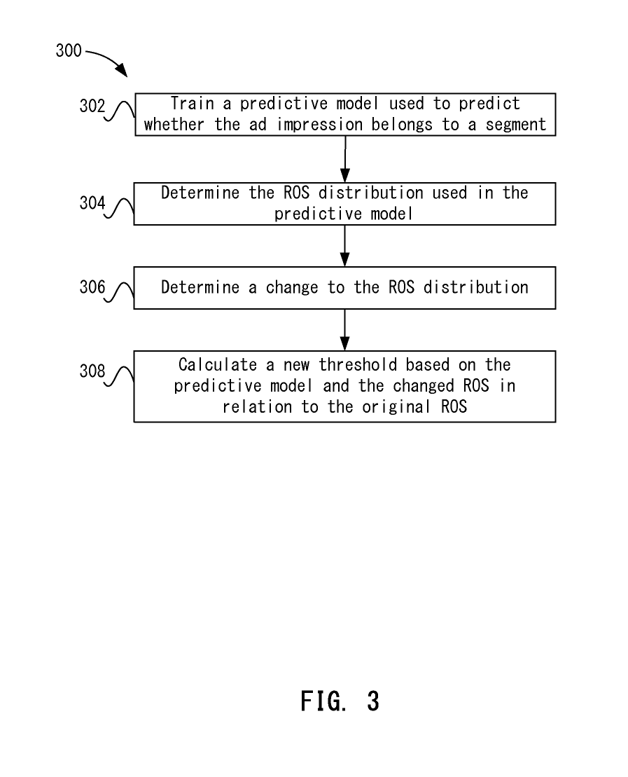

To keep the precision stable, as discussed above, ad targeting manager 106 adjusts the threshold that is used to determine if the ad impression belongs to the segment. FIG. 3 depicts a simplified flowchart 300 of a method for adjusting the threshold according to one embodiment. At 302, ad targeting manager 106 trains a predictive model used to predict whether the ad impression belongs to a segment. The predictive model predicts a probability, such as a posterior probability, referred to as p(s|x), which is the probability that an ad impression belongs to a specific segment s given the user's features x. The user's features may be a feature vector x, which is extracted from characteristics of the user who viewed the ad, such as a user's profile and/or behaviors, and/or the ad's properties. As discussed above, the probability is compared to a threshold. Ad targeting manager 106 assumes that the ad impression belongs to the segment s if the probability is no less than a threshold t and can be represented as follows:

p(s|x)>=t (Eq. 1)

A higher threshold means higher precision (e.g., it is more likely that a user is a female between the ages of 18 and 34). As a result, if ad targeting manager 106 raises the threshold, the ad impressions determined as targeted will be more precise. In the opposite sense, if the threshold is lowered, then less ad impressions will be targeted and the targeting precision decreases.

The ROS distribution may change over time, which may affect the targeting precision. However, ad targeting manager 106 may not be able to test the precision directly because there are anonymous users whose sex and age are unknown, and also registered users may provide the wrong profile information. But, ad targeting manager 106 may use the ROS distribution changes to adjust the threshold to maintain the precision. The threshold is changed such that the precision may remain stable when the ROS distribution changes. For example, when an ad targeting product is for females between the ages of 18 and 34 (FA18 to 34), an ROS probability may be 20%, which means 20% of site impressions are from females between the ages of 18 and 34. If the ROS probability drops, then the precision of the ad targeting for the product FA18 to 34 drops accordingly. In the extreme case, the ROS probability becomes 0, which means there are no ad impressions from a female between the ages of 18 and 34 for the entire site, and thus the precision of the product FA18 to 34 drops to 0.

In another example, during the holidays, the ROS probability drops from 20% to 10% for females between the ages of 18 and 34. This observation may be made using various factors, such as observing the registered users whose gender and age are known and determining that the ROS probability drops from 20% to 10% based on those observations. Many anonymous users may use the site where the gender and age of these anonymous users are not known. Thus, ad targeting manager 106 may not know how much the precision drops. However, using the change in the ROS, ad targeting manager 106 may calculate a new threshold. Changing the threshold when the ROS distribution changes may keep the precision relatively stable.

Referring back to FIG. 3, at 304, ad targeting manager 106 determines the ROS distribution used in the predictive model. The ROS distribution may be a probability. That is, there is an 80% probability of the users are male on a given day. Then, at 306, ad targeting manager 106 determines a change to the ROS distribution. Once determining the changed ROS distribution, at 308, ad targeting manager 106 calculates a new threshold based on the predictive model and the changed ROS in relation to the original ROS.

To calculate the new threshold, the following calculation will be described; however, variations of the calculation may be appreciated. In the example below, the probability p(s|x) may be as follows:

$$p ( s \vert x ) = \frac{p ( s ) p ( x \vert s )}{p ( s ) p ( x \vert s ) + p ( \overline{s} ) p ( x \vert \overline{s} )} \qquad ( Eq . 2 )$$

When the ROS probability changes from p(s) to q(s), the probability changes from p(s|x) to q(s|x). That is, ad targeting manager 106 determines a new probability, such as a new posterior probability q(s|x). As discussed above, the segment s is the segment that is being targeted, such as females between the ages of 18 and 34, males between the ages of 25 and 54, or other segments. The opposite set of the segment is s̅. This is the complementary set of the segment s if the segment s stands for females between the ages of 18 and 34, then s̅ stands for all the males, and females that are younger than 18 or older than 34. Also, p(s) is equal to 1−q( s̅) The new probability may be expressed as follows:

$$q ( s \vert x ) = \frac{q ( s ) p ( x \vert s )}{q ( s ) p ( x \vert s ) + q ( \overline{s} ) p ( x \vert \overline{s} )} \qquad ( Eq . 3 )$$

If Eq. 2 had substituted into Eq. 3, the probability q(s|x) becomes:

$$q ( s \vert x ) = \frac{p ( s \vert x ) q ( s ) p ( \overline{s} )}{p ( s \vert x ) q ( s ) p ( \overline{s} ) + ( 1 - p ( s \vert x ) ) q ( \overline{s} ) p ( s )} \qquad ( Eq . 4 )$$

If the original threshold is t, ad targeting manager 106 may choose a new threshold h such that:

$$\frac{{\sum }_{i} q ( s \vert {x}_{i} ) I ( q ( s \vert {x}_{i} ) > h )}{{\sum }_{i} I ( q ( s \vert {x}_{i} ) > h )} = \frac{{\sum }_{i} p ( s \vert {x}_{i} ) I ( p ( s \vert {x}_{i} ) > t )}{{\sum }_{i} I ( p ( s \vert {x}_{i} ) > t )} \qquad ( Eq . 5 )$$

where i is the index of each ad impression and

$$I ( b ) = \{ \begin{matrix}1 & b is true \\ 0 & b is false\end{matrix} , \qquad ( Eq . 6 )$$

where b is any logic expression. By changing the threshold h using the above equation, the precision remains stable. Ad targeting manager 106 assumes that the ad impression belongs to the segment s if the new probability is no less than a threshold t and can be represented as follows:

q(s|x)>=h (Eq. 7)

As Eq. 4, the probability p(s|x) is as follows:

$$p ( s \vert x ) = \frac{q ( s \vert x ) p ( s ) q ( \overline{s} )}{q ( s \vert x ) p ( s ) q ( s ) + ( 1 - q ( s \vert x ) ) p ( s ) q ( s )} \qquad ( Eq . 8 )$$

Applying Eq. 8 to Eq. 7, ad targeting manager 106 assumes that the ad impression belongs to the segment s if the original probability is no less than a threshold t″

$$\begin{matrix}p ( s \vert x ) >= {t}^{′} \\ where & ( Eq . 9 ) \\ {t}^{′} = \frac{hp ( s ) q ( \overline{s} )}{hp ( s ) q ( \overline{s} ) + ( 1 - h ) p ( \overline{s} ) q ( s )} & ( Eq . 10 )\end{matrix}$$

The Eq. 9 is equivalent to Eq. 7.

In equations 2-10, “x” is a feature vector. The feature vectors are features that are associated with the user that viewed the ad impression, such as features for the user are extracted from the user's profile, behaviors, or other information. For example, a user's features may include the shows the user watched, votes that the user submitted, or other features. For example, a user may have watched a show called “Family Guy” and is assigned the feature “watched_family_guy” or the user may have voted for the Toyota brand and receives a feature of “voted_up_toyota”. A set of features for the user makes up the user's feature vector x.

The probability p(s) is the ROS probability of the segment s. If the segment s stands for females between the ages of 18 and 34 (FA18 to 34), and there are 100 million ad impressions every day on the site and 40 million of those ad impressions are from females between the ages of 18 and 34, then p(s) is 0.4. The probability p( s̅) is the ROS probability of the segment s̅. Using the above example, the probability p( s̅) is 0.6 ( 60/100).

The probability p(x|s) is a probability, such as a conditional probability, that an ad impression is from a user having a feature vector x given the user belongs to a segment s. For example, if there are 40 million ad impressions that belong to the segment s every day, and 1 million of these impressions have a feature vector x, then p(x|s) is 0.025. For example, the feature vector x may be “watched_family_guy” and “watched_glee”.

The probability p(x| s̅) is a probability, such as a conditional probability, that the ad impression is from a user having feature vector x given that the user does not belong to the segment s. For example, if there are 60 million ad impressions not from segment s every day, and 3 million of the 60 million ad impressions have a feature vector x, then p(x| s̅) is 0.05.

The p(s|x) is a probability, such as a posterior probability, that a user belongs to the segment s given that the user's feature vector is x. Following the two examples above, if there are 4 million ad impressions from users with the feature vector x (e.g. “watched_family_guy”, “watched_glee”), and 1 million of them are from users that are of segment s, then p(s|x) equals 0.25. The probability p(s|x) may be estimated by a predictive model, such as machine-learning algorithms.

Eq. 2 may be based on Bayes' theory and may be determined as follows:

$$p ( s \vert x ) = \frac{p ( s , x )}{p ( x )} = \frac{p ( s , x )}{p ( s , x ) + p ( \overline{s} , x )} = \frac{p ( s ) p ( x \vert s )}{p ( s ) p ( x \vert \overline{s} ) + p ( s ) p ( x \vert \overline{s} )}$$

In the above, the probability p(s|x) is equal to the number of ad impressions from users of segment s that have the feature x divided by the number of ad impressions from users that have feature x. The number of ad impressions from users that have feature x may be translated into the number of ad impressions from users of segment s that have feature x plus the number of ad impressions from users of segment s̅ that have feature x. Then, the denominator may be translated into the number of ad impressions from users of segment s multiplied by how much of a portion of segment s is from users having feature x plus the number of ad impressions from users of segment s̅ is from users that have feature vector x. This can be translated as follows:
“p(s|x)=(number of impressions from users of segment s that have feature x)/(number of impressions from users that have feature x)
=(number of impressions from users of segment s that have feature x)/(number of impressions from users of segment s that have feature x+number of impressions from users of segment s̅ that have feature x)
=(number of impressions from users of segment s that have feature x)/(number of impressions from users of segment s*how much portion of segment s is from users having feature x+number of impressions from users of segment s̅*how much portion of segment s̅ is from users have behaviors vector x)”

Referring to equation 3, the new ROS probability q(s) is similar to the ROS probability p(s), which is the original ROS probability of segment s. The original probability p(s) is out of date because of the ROS changes. The probability q(s) stands for the new ROS probability. The probability q( s̅) is the new ROS probability of p( s̅). Also, the probability q(s|x) is similar to the probability p(s|x). The probability p(s|x) is the original estimated posterior probability, which is out of date after the ROS change, and the probability q(s|x) is the new posterior probability. Equation 3 may be determined similarly to equation 2. Also, equation 4 is determined by substituting equation 2 into equation 3.

Referring to equation 5, the threshold t may be a pre-defined threshold. For the segment of females between the ages of 18 and 34, ad targeting manager 106 may not know exactly whether an ad impression is from a user belonging to the segment. However, ad targeting manager 106 may know the probability by applying a predictive model, such as machine-learning algorithms. Then, once having the probability, for ad impressions having higher probabilities than the threshold t, ad targeting manager 106 assumes they belong to the segment.

In equation 5, the summation:

$${\sum }_{i} l ( p ( s \vert {x}_{i} ) > t )$$

sums up all the targeted ad impressions (e.g., ad impressions with a higher probability than the original threshold t). The summation:

$${\sum }_{i} p ( s \vert {x}_{i} ) l ( p ( s \vert {x}_{i} ) > t )$$

also sums up all the targeted ad impressions, but multiplies the ad impressions by the probability that it belongs to the segment s. As a result, this summation stands for the expected number of ad impressions that belong to segment s.

The summation:

$$\frac{{\sum }_{i} p ( s \vert {x}_{i} ) l ( p ( s \vert {x}_{i} ) > t )}{{\sum }_{i} l ( p ( s \vert {x}_{i} ) > t )}$$

is the expected targeting precision, which is the estimated targeting precision. Since the numerator is the expected number of ad impressions that belong to segment s and the denominator is the total number of ad impressions, this provides the expected targeting precision. The full equation 5 is as follows then:

$$\frac{{\sum }_{i} q ( s \vert {x}_{i} ) l ( q ( s \vert {x}_{i} ) > h )}{{\sum }_{i} l ( q ( s \vert {x}_{i} ) > h )} = \frac{{\sum }_{i} p ( s \vert {x}_{i} ) l ( p ( s \vert {x}_{i} ) > t )}{{\sum }_{i} l ( p ( s \vert {x}_{i} ) > t )} .$$

h is the new threshold after the ROS probability changes and is calculated by ad targeting manager 106. In the above, the threshold h is the only unknown value and ad targeting manager 106 can calculate the value of h, such as by using a line search for the threshold h's value. Eq. 5 means that if the new threshold satisfies the above condition, then the expected target precision after the ROS change is the same as before.

Once determining the new threshold h, referring back to FIG. 3, ad targeting manager 106 applies the new threshold to the predictive model when performing ad targeting analysis. For example, when probability q(s|x) is calculated, ad targeting manager 106 compares the probability to the new threshold. If the probability is above the threshold, then ad targeting manager 106 determines that the ad impression was targeted. If the probability is below the threshold h, then ad targeting manager 106 determines that the ad impression was not targeted.

The following provides an example that describes the changes in probability. If the segment s is females between the ages of 18 and 34 (FA18 to 34), the feature vector x is [“watched_family_guy”, “watched_glee”]. Also, there may be 100 million ad impressions per day. Before the ROS change, 40 million of the ad impressions belong to the segment FA18 to 34. One million ad impressions are from users with the feature vector x and belong to the segment s, which means that the user may have watched Family Guy and Glee, and is a female between the ages of 18 and 34. Three million ad impressions are from users with the feature vector x but do not belong to the segment s, which means that the user may have watched Family Guy and Glee, but is not a female between the ages of 18 and 34. After the ROS change, there are still 100 million ad impressions per day, but only 20 million are from females between the ages of 18 and 34, and 80 million are not.

To calculate the probability q(s|x), equations 3 and 4 can be used to receive the same result. However, ad targeting manager 106 may not be able to use equation 3 because the probability p(x|s) and p(x| s̅) are unknown. However, ad targeting manager 106 knows the probability that a user belongs to segment s given the user's feature vector is x. For example, machine learning models, such as SVM, Logistic regression, Decision tree, and boosting, can be used to determine the probability that a user belongs to segment s given the users' feature vector is x. Accordingly, ad targeting manager 106 may use equation 4 to determine the probability q(s|x). Table I shows the values and details for determining equation 4. The result of equation 3 is also shown.

TABLE I

| Symbol | Value | Details |
|---|---|---|
| s | FA18to34 | |
| s̅ | Male, FA0to17 | |
| | and FA35up | |
| p(s) | 0.4 | 40 millions/100 millions |
| p( s̅) | 0.6 | 60 millions/100 millions |
| p(x\|s) | 0.025 | 1 millions/40 millions |
| p(x\| s̅) | 0.05 | 3 millions/60 millions |
| p(s\|x) | 0.25 | 1 millions/(1 + 3 millions) |
| q(s) | 0.2 | 20 millions/100 millions |
| q( s̅) | 0.8 | 80 millions/100 millions |
| q(s\|x) − equation 4 | 0.111 | 0.25*0.2*0.6/(0.25*0.2*0.6 + |
| | | (1 − 0.25)*0.8*0.4) |
| q(s\|x) − equation 3 | 0.111 | 0.2*0.025/(0.2*0.025 + |
| | | 0.8*0.05) |

The new probability q(s|x) may then be used to calculate the new threshold h. For example, if the original ROS is 40% and the new ROS is 35%, ad targeting manager 106 can determine q(s|x) from p(s|x) as shown in the following table I.

TABLE I

| impr index | p(s\|x) | q(s\|x) |
|---|---|---|
| 1 | 0.8 | 0.76 |
| 2 | 0.75 | 0.71 |
| 3 | 0.5 | 0.45 |
| 4 | 0.6 | 0.55 |
| 5 | 0.8 | 0.76 |
| 6 | 0.9 | 0.88 |
| 7 | 0.65 | 0.60 |
| 8 | 0.4 | 0.35 |
| 9 | 0.3 | 0.26 |
| 10 | 0.7 | 0.65 |

In Table I, impr index is each ad impression and the values for p(s|x) and q(s|x) are listed for each respective ad impression. If the original threshold t is 0.6, ad targeting manager 106 calculates the original expected precision as 74.3%. A higher threshold h will yield higher expected precision. Ad targeting manager 106 can apply linear line search (try 0, 0.01, 0.02, . . . , , 0.99 one by one) or a binary search to find the best solution for the threshold h. In this problem, ad targeting manager 106 determines 0.63 is the best solution. Also, when h=0.63, the expected precision is 75.4%. With Eq. 10, t′=0.678 is determined. It should be noted that the new and original expected precisions may not be exactly the same.

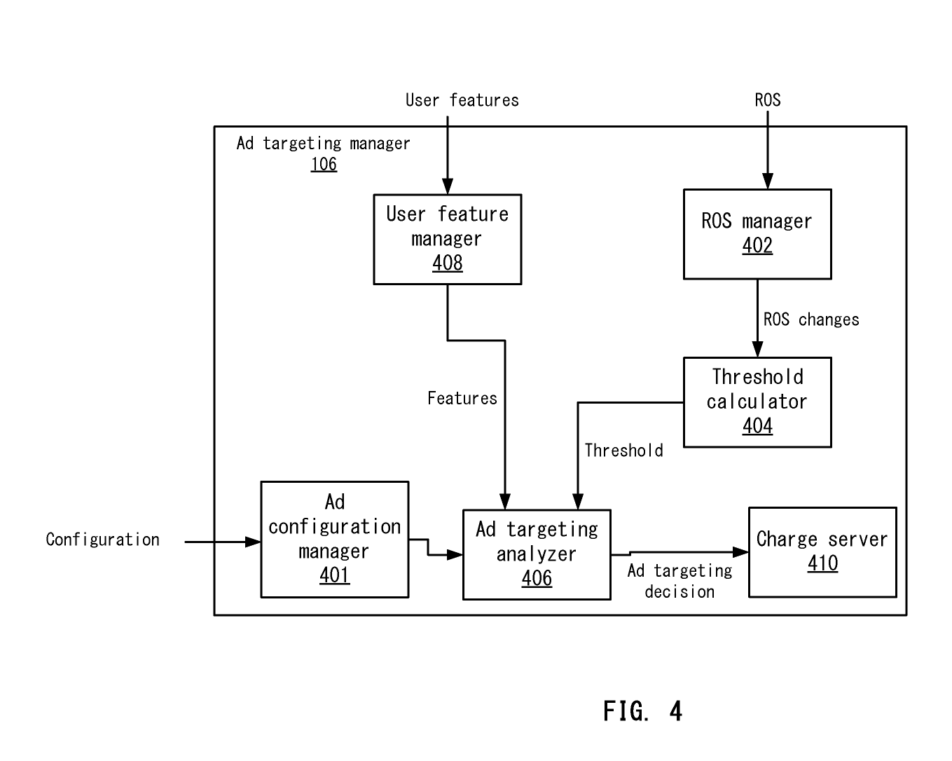

FIG. 4 depicts a more detailed example of ad targeting manager 106 according to one embodiment. An ad configuration manager 401 receives configuration information from advertisers. For example, an advertiser may designate which ad product is desired, which segment should be targeted, etc. Ad configuration manager 401 then configures the ad targeting product.

An ROS manager 402 determines ROS distribution changes. The ROS distribution changes may be determined based on data from the site or third-party data. ROS manager 402 sends the ROS changes to a threshold calculator 404.

Threshold calculator 404 uses the ROS distribution changes to determine a new threshold h. The new threshold h is determined as described above and applies to the new probability that is based on the new ROS probability. Threshold calculator 404 sends the threshold to an ad targeting analyzer 406.

Ad targeting analyzer 406 receives features for a user from a user feature manager 408. User feature manager 408 may determine the features of a user based on a user's profile, behaviors, or other information. Ad targeting analyzer 406 also receives corresponding ad impressions. As described above, ad targeting analyzer 406 determines a probability using the predictive model that a user for the ad impression belongs to a segment based on the user's features. After comparing that probability to the new threshold h, ad targeting analyzer 406 outputs an ad targeting decision to charge server 410. Charge Server 410 determines a charge for the ad impression based on whether the ad was targeted or not. It should be noted that charge server 410 may be independent from the site where a third party determines whether or not to charge for the ad impression or not.

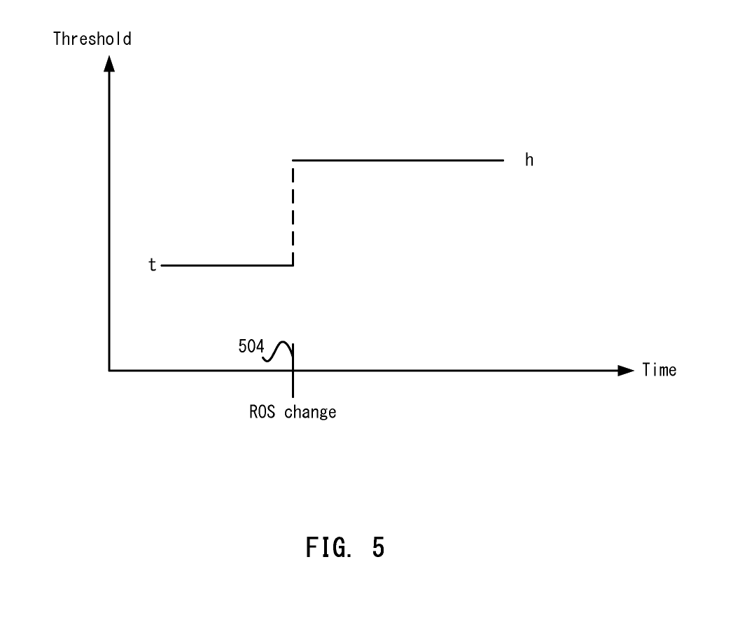

FIG. 5 depicts a graph 500 showing the changes in the threshold according to one embodiment. The y axis of graph 500 is the threshold value and the x axis is the time. At 502, the threshold is at a value of t. As shown at 504, an ROS distribution change occurs. At this point, ad targeting manager 106 may calculate a new threshold h. As shown at 506, the threshold has been changed to a value of h. This process may continue as ROS changes may be determined over time, which causes changes in the threshold to keep the targeting precision stable. Accordingly, the targeting precision does not substantially fluctuate when the ROS distribution fluctuates.

### System Overview

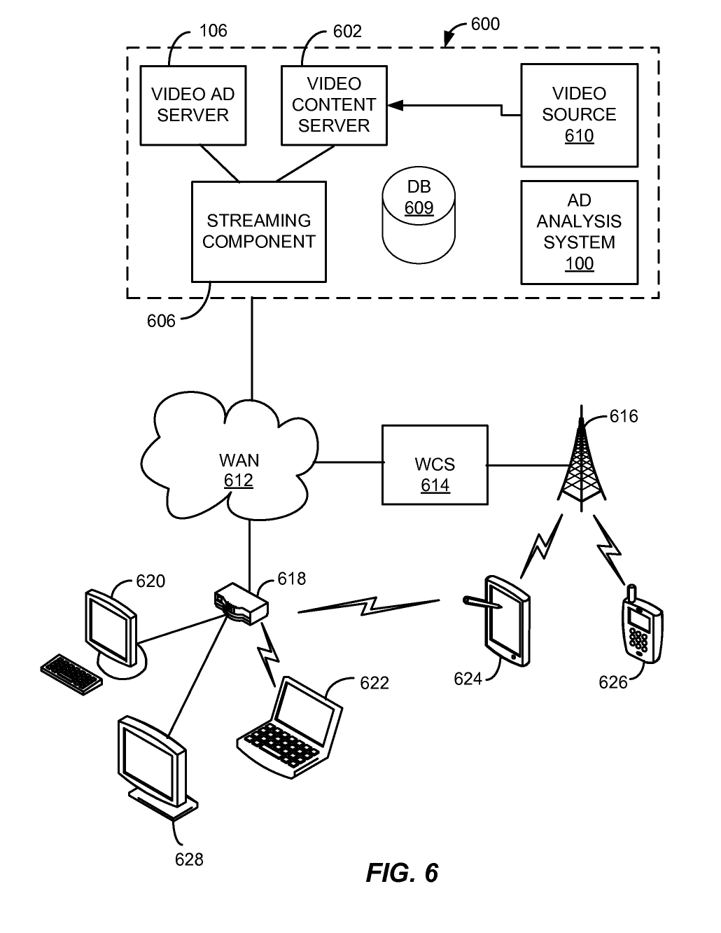

Features and aspects as disclosed herein may be implemented in conjunction with a video streaming system 600 in communication with multiple client devices via one or more communication networks as shown in FIG. 6. Aspects of the video streaming system 600 are described merely to provide an example of an application for enabling distribution of content prepared according to the present disclosure. It should be appreciated that the present technology is not limited to streaming video applications, and may be adapted for other applications.

Video data may be obtained from one or more sources for example, from a video source 610, for use as input to a video content server 602. The input video data may comprise raw or edited frame-based video data in any suitable digital format, for example, MPEG-1, MPEG-2, MPEG-4, VC-1, or other format. In an alternative, a video may be provided in a non-digital format and converted to digital format using a scanner and/or transcoder. The input video data may comprise video clips or programs of various types, for example, television episodes, motion pictures, and other content produced as primary content of interest to consumers.

The video streaming system 600 may include one or more computer servers or modules 602, 108, and/or 606 distributed over one or more computers. Each server 602, 108, 606 may include, or may be operatively coupled to, one or more data stores 609, for example databases, indexes, files, or other data structures. A video content server 602 may access a data store (not shown) of various video segments. The video content server 602 may serve the video segments as directed by a user interface controller communicating with a client device. As used herein, a video segment refers to a definite portion of frame-based video data, such as may be used in a streaming video session to view a television episode, motion picture, recorded live performance, or other video content.

In some embodiments, a video advertising server 108 may access a data store of relatively short videos (e.g., 10 second, 30 second, or 60 second video advertisements) configured as advertising for a particular advertiser or message. The advertising may be provided for an advertiser in exchange for payment of some kind, or may comprise a promotional message for the system 600, a public service message, or some other information. The ad server 108 may serve the video advertising segments as directed by a user interface controller (not shown).

The video streaming system 600 also may include ad analysis system 100. Ad analysis system 100 receives information for ad impressions from video ad server 108, or other components.

The video streaming system 600 may further include an integration and streaming component 606 that integrates video content and video advertising into a streaming video segment. A controller (not shown) may determine the selection or configuration of advertising in the streaming video based on any suitable algorithm or process. The video streaming system 600 may include other modules or units not depicted in FIG. 6, for example administrative servers, commerce servers, network infrastructure, advertising selection engines, and so forth.

The video streaming system 600 may connect to a data communication network 612. A data communication network 612 may comprise a local area network (LAN), a wide area network (WAN), for example, the Internet, a telephone network, a wireless cellular telecommunications network 614, or some combination of these or similar networks.

One or more client devices may be in communication with the video streaming system 600, via the data communication network 612 and/or other network 614. Such client devices may include, for example, one or more laptop computers 622, desktop computers 620, “smart” mobile phones 626, notepad devices 624, network-enabled televisions 628, or combinations thereof, via a router 618 for a LAN, via a base station 616 for a wireless telephony network 614, or via some other connection. In operation, such client devices 620, 622, 624, 626, or 628 may send and receive data or instructions to the system 600, in response to user input received from user input devices or other input. In response, the system 600 may serve video segments and metadata from the data store 609 responsive to selection of interactive links to the client devices 620, 622, 624, 626, or 628 and customize the additional content based on parameters of the client devices, for example respective geographic locations of the client devices, or demographic information concerning respective users of the client devices. The devices 620, 622, 624, 626, or 628 may output interactive video content from the streaming video segment using a display screen, projector, or other video output device, and receive user input for interacting with the video content based on one or more links associated with a tracked face or other object appearing in the video content.

Distribution of audio-video data may be implemented from a content server 606 to remote client devices over computer networks, telecommunications networks, and combinations of such networks, using various methods, for example streaming. In streaming, a server streams audio-video data continuously to a media player component operating at least partly on the client device, which may play the audio-video data concurrently with receiving the streaming data from the server. Although streaming is discussed, other methods of delivery may be used. The media player component may initiate play of the video data immediately after receiving an initial portion of the data from the content provider. Traditional streaming techniques use a single provider delivering a stream of data to a set of end users. High bandwidths and processing power may be required to deliver a single stream to a large audience, and the required bandwidth of the provider may increase as the number of end users increases.

Streaming media can be delivered on-demand or live. Streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities via a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player on the destination client. Unlike the web server, the streaming media server 606 may communicate with the client device using control messages and data messages to adjust to changing network conditions as the video is played. These control messages can include commands for enabling control functions such as fast forward, fast reverse, pausing, or seeking to a particular part of the file at the client.

Since a streaming media server 606 transmits video data only as needed and at the rate that is needed, precise control over the number of streams served can be maintained. The viewer will not be able to view high data rate videos over a lower data rate transmission medium. However, streaming media servers (1) provide users random access to the video file, (2) allow monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming media servers may use HTTP and TCP to deliver video streams, but generally use RSTP (real time streaming protocol) and UDP (user datagram protocol). These protocols permit control messages and save bandwidth by reducing overhead. Unlike TCP, when data is dropped during transmission, UDP does not transmit resent requests. Instead, the server continues to send data. Streaming media servers can also deliver live webcasts and can multicast, which allows more than one client to tune into a single stream, thus saving bandwidth. Streaming media players may not rely on buffering to provide random access to any point in the media program. Instead, this is accomplished through the use of control messages transmitted from the media player to the streaming media server. Another protocol used for streaming is hypertext transfer protocol (HTTP) live streaming (HLS). The HLS protocol delivers video over HTTP via a playlist of small segments that are made available in a variety of bitrates typically from one or more content delivery networks (CDNs). This allows a media player to switch both bitrates and content sources on a segment-by-segment basis. The switching helps compensate for network bandwidth variances and also infrastructure failures that may occur during playback of the video.

The delivery of video content by streaming may be accomplished under a variety of models. In one model, the user pays for the viewing of each video program, for example, using a pay-per-view service. In another model widely adopted by broadcast television shortly after its inception, sponsors pay for the presentation of the media program in exchange for the right to present advertisements during or adjacent to the presentation of the program. In some models, advertisements are inserted at predetermined times in a video program, which times may be referred to as “ad slots” or “ad breaks.” With streaming video, the media player may be configured so that the client device cannot play the video without also playing predetermined advertisements during the designated ad slots.

Output from a media player on the client device may occupy only a portion of total screen area available on a client device, particularly when bandwidth limitations restrict the resolution of streaming video. Although media players often include a “full screen” viewing option, many users prefer to watch video in a display area smaller than full screen, depending on the available video resolution. Accordingly, the video may appear in a relatively small area or window of an available display area, leaving unused areas. A video provider may occupy the unused area with other content or interface objects, including additional advertising, such as, for example, banner ads. Banner ads or similar additional content may be provided with links to an additional web site or page, so that when a user “clicks on” or otherwise selects the banner ad, the additional web site or page opens in a new window. Additional screen space, when available, may also be used for displaying additional information responsive to selection of links associated with face tracks in video content, as described in more detail elsewhere herein.

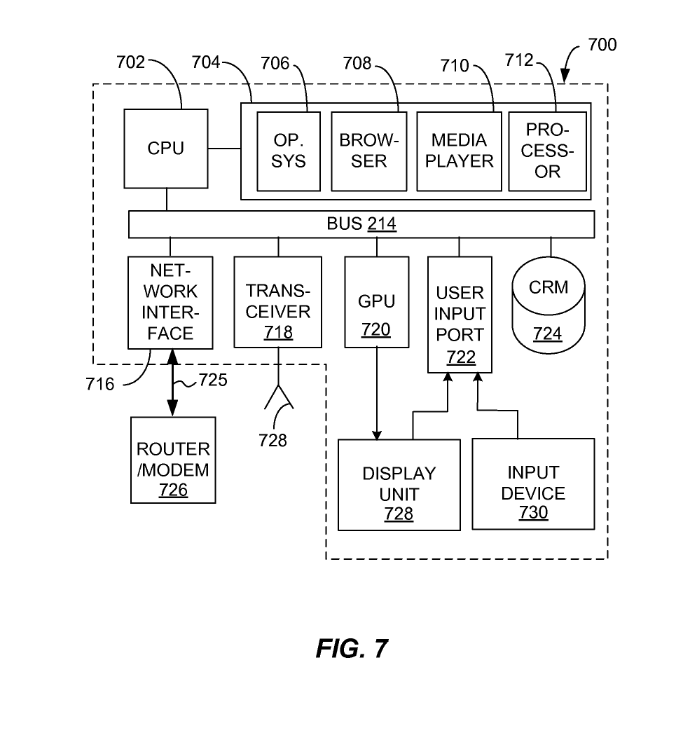

Referring to FIG. 7, a diagrammatic view of an apparatus 700 for viewing video content and advertisements is illustrated. In selected embodiments, the apparatus 700 may include a processor 702 operatively coupled to a processor memory 704, which holds binary-coded functional modules for execution by the processor 702. Such functional modules may include an operating system 706 for handling system functions such as input/output and memory access, a browser 708 to display web pages, and media player 710 for playing video. The modules may further include ad processor 712 for outputting advertisements. The memory 704 may hold additional modules not shown in FIG. 7, for example modules for performing other operations described elsewhere herein.

A bus 714 or other communication component may support communication of information within the apparatus 700. The processor 702 may be a specialized or dedicated microprocessor configured to perform particular tasks in accordance with the features and aspects disclosed herein by executing machine-readable software code defining the particular tasks. Processor memory 704 (e.g., random access memory (RAM) or other dynamic storage device) may be connected to the bus 714 or directly to the processor 702, and store information and instructions to be executed by a processor 702. The memory 704 may also store temporary variables or other intermediate information during execution of such instructions.

A computer-readable medium in a storage device 724 may be connected to the bus 714 and store static information and instructions for the processor 702; for example, the storage device 724 may store the modules 706, 708, 710 and 712 when the apparatus 700 is powered off, from which the modules may be loaded into the processor memory 704 when the apparatus 700 is powered up. The storage device 724 may include a non-transitory computer-readable storage medium holding information, instructions, or some combination thereof, for example instructions that when executed by the processor 702, cause the apparatus 700 to be configured to perform one or more operations of a method as described herein.

A communication interface 716 may also be connected to the bus 714. The communication interface 716 may provide or support two-way data communication between the apparatus 700 and one or more external devices, e.g., the streaming system 600, optionally via a router/modem 726 and a wired or wireless connection 725. In the alternative, or in addition, the apparatus 700 may include a transceiver 718 connected to an antenna 728, through which the apparatus 700 may communicate wirelessly with a base station for a wireless communication system or with the router/modem 726. In the alternative, the apparatus 700 may communicate with a video streaming system 600 via a local area network, virtual private network, or other network. In another alternative, the apparatus 700 may be incorporated as a module or component of the system 600 and communicate with other components via the bus 714 or by some other modality.

The apparatus 700 may be connected (e.g., via the bus 714 and graphics processing unit 720) to a display unit 728. A display 728 may include any suitable configuration for displaying information to an operator of the apparatus 700. For example, a display 728 may include or utilize a liquid crystal display (LCD), touchscreen LCD (e.g., capacitive display), light emitting diode (LED) display, projector, or other display device to present information to a user of the apparatus 700 in a visual display.

One or more input devices 730 (e.g., an alphanumeric keyboard, microphone, keypad, remote controller, game controller, camera or camera array) may be connected to the bus 714 via a user input port 722 to communicate information and commands to the apparatus 700. In selected embodiments, an input device 730 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 728, for example using a touch sensitive screen. A cursor control device may communicate direction information and command selections to the processor 702 and control cursor movement on the display 728. A cursor control device may have two or more degrees of freedom, for example allowing the device to specify cursor positions in a plane or three-dimensional space.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be configured to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
training, by a computing device, a predictive model configured to predict a probability that advertisement (ad) impressions belong to a segment that is being targeted, the ad impressions provided during sending of videos to users;
determining, by the computing device, a first threshold in which the probability predicted from the predictive model is compared to determine whether ad impressions belong to the segment;
determining, by the computing device, a distribution probability used in the training of the predictive model, the distribution probability being determined based on a characteristic for ad impressions on a site;
determining, by the computing device, a changed distribution probability for the site; and
determining, by the computing device, a second threshold in which the probability predicted from the predictive model is compared to determine whether ad impressions belong to the segment.

2. The method of claim 1, wherein the predictive model predicts whether an ad impression belongs to the segment based on one or more features associated with the ad impression.

3. The method of claim 2, wherein the one or more features are associated with a user viewing the ad impression.

4. The method of claim 1, wherein the second threshold is determined based on keeping a precision substantially stable.

5. The method of claim 1, further comprising:
determining an ad impression;
determining if the ad impression belongs to the segment based on a user's features using the predictive model and the second threshold;
if the predictive model determines a probability above the second threshold indicating the ad impression belongs to the segment, adding the ad impression as a targeted ad impression to the segment; and
if the predictive model determines a probability below the second threshold indicating the ad impression does not belong to the segment, not adding the ad impression as a targeted ad impression to the segment.

6. The method of claim 1, wherein the distribution probability is a run of site (ROS) probability based on all ad impressions provided by the site.

7. The method of claim 6, where when the ROS probability changes, precision changes for the predictive model based on the ROS probability changes.

8. The method of claim 7, further comprising computing the second threshold based on a probability for the predictive model before the ROS probability changes and a probability for the predictive model after the ROS probability changes.

9. The method of claim 1, wherein the second threshold is computed by:
determining an expected number of ad impressions that belong to the segment;
determining a total number of ad impressions; and
dividing the expected number of ad impressions by the total number of ad impressions.

10. The method of claim 9, wherein the second threshold is computed by:
summing up targeted ad impressions to generate the total number of ad impressions; and
summing up the targeted ad impressions and multiplying the summed ad impressions by the probability that the ad impression belongs to the segment s to generate the expected number of ad impressions that belong to the segment.

11. The method of claim 10, wherein the expected number of ad impressions divided by the total number of ad impressions comprises:
$$\frac{{\sum }_{i} p ( s \vert {x}_{i} ) l ( p ( s \vert {x}_{i} ) > t )}{{\sum }_{i} l ( p ( s \vert {x}_{i} ) > t )} ,$$
where p(s|x) is a probability that a user belongs to the segment s given that a user who viewed the ad impression has a feature vector x, i is an index, and t is the first threshold.

12. The method of claim 1, wherein the second threshold is computed as follows:
$$\frac{{\sum }_{i} q ( s \vert {x}_{i} ) l ( q ( s \vert {x}_{i} ) > h )}{{\sum }_{i} l ( q ( s \vert {x}_{i} ) > h )} = \frac{{\sum }_{i} p ( s \vert {x}_{i} ) l ( p ( s \vert {x}_{i} ) > t )}{{\sum }_{i} l ( p ( s \vert {x}_{i} ) > t )} ,$$
where i is an index, p(s|x) is a probability that a user belongs to the segment s given that a user who viewed the ad impression has a feature vector x, q(s|x) is a probability that a user belongs to the segment s given that a user who viewed the ad impression feature vector is x after the ROS probability changes, t is the first threshold, and h is the second threshold, and
$$l ( b ) = \{ \begin{matrix}1 & b is true \\ 0 & b is false\end{matrix} .$$

13. The method of claim 12, wherein:
p(s|x) is:
$$p ( s \vert x ) = \frac{p ( s ) p ( x \vert s )}{p ( s ) p ( x \vert s ) + p ( \overline{s} ) p ( x \vert \overline{s} )} ,$$
and
q(s|x) is:
$$q ( s \vert x ) = \frac{q ( s ) p ( x \vert s )}{q ( s ) p ( x \vert s ) + q ( \overline{s} ) p ( x \vert \overline{s} )} , or \\ q ( s \vert x ) ) = \frac{p ( s \vert x ) q ( s ) p ( \overline{s} )}{p ( s \vert x ) q ( s ) p ( \overline{s} ) + ( 1 - p ( s \vert x ) ) q ( \overline{s} ) p ( s )} .$$

14. A non-transitory computer-readable storage medium containing instructions, that when executed, control a computer system to be configured for:
training a predictive model configured to predict a probability that advertisement (ad) impressions belong to a segment that is being targeted, the ad impressions provided during sending of videos to users;
determining a first threshold in which the probability predicted from the predictive model is compared to determine whether ad impressions belong to the segment;
determining a distribution probability used in the training of the predictive model, the distribution probability being determined based on a characteristic for ad impressions on a site;
determining a changed distribution probability for the site; and
determining a second threshold in which the probability predicted from the predictive model is compared to determine whether ad impressions belong to the segment.

15. The non-transitory computer-readable storage medium of claim 14, wherein the predictive model predicts whether an ad impression belongs to the segment based on one or more features associated with the ad impression.

16. The non-transitory computer-readable storage medium of claim 14, wherein the second threshold is determined based on keeping a precision substantially stable.

17. The non-transitory computer-readable storage medium of claim 14, further configured for:
determining an ad impression;
determining if the ad impression belongs to the segment based on a user's features using the predictive model and the second threshold;
if the predictive model determines a probability above the second threshold indicating the ad impression belongs to the segment, adding the ad impression as a targeted ad impression to the segment; and
if the predictive model determines a probability below the second threshold indicating the ad impression does not belong to the segment, not adding the ad impression as a targeted ad impression to the segment.

18. The non-transitory computer-readable storage medium of claim 14, wherein the second threshold is computed by
determining an expected number of ad impressions that belong to the segment;
determining a total number of ad impressions; and
dividing the expected number of ad impressions by the total number of ad impressions.

19. The non-transitory computer-readable storage medium of claim 18, wherein the second threshold is computed by:
summing up targeted ad impressions to generate the total number of ad impressions; and
summing up the targeted ad impressions and multiplying the summed ad impressions by the probability that the ad impression belongs to the segment s to generate the expected number of ad impressions that belong to the segment.

20. The non-transitory computer-readable storage medium of claim 19, wherein the expected number of ad impressions divided by the total number of ad impressions comprises:
$$\frac{{\sum }_{i} p ( s \vert {x}_{i} ) l ( p ( s \vert {x}_{i} ) > t )}{{\sum }_{i} l ( p ( s \vert {x}_{i} ) > t )} ,$$
where p(s|x) is a probability that a user belongs to the segment s given that a user who viewed the ad impression has a feature vector x, i is an index, and t is the first threshold.

21. The non-transitory computer-readable storage medium of claim 14, wherein the second threshold is computed as follows:
$$\frac{{\sum }_{i} q ( s \vert {x}_{i} ) l ( q ( s \vert {x}_{i} ) > h )}{{\sum }_{i} l ( q ( s \vert {x}_{i} ) > h )} = \frac{{\sum }_{i} p ( s \vert {x}_{i} ) l ( p ( s \vert {x}_{i} ) > t )}{{\sum }_{i} l ( p ( s \vert {x}_{i} ) > t )} ,$$
where i is an index, p(s|x) is a probability that a user belongs to the segment s given that a user who viewed the ad impression has a feature vector x, q(s|x) is a probability that a user belongs to the segment s given that a user who viewed the ad impression feature vector is x after the ROS probability changes, t is the first threshold, and h is the second threshold, and
$$l ( b ) = \{ \begin{matrix}1 & b is true \\ 0 & b is false\end{matrix} .$$

22. The non-transitory computer-readable storage medium of claim 21, wherein:
p(s|x) is:
$$p ( s \vert x ) = \frac{p ( s ) p ( x \vert s )}{p ( s ) p ( x \vert s ) + p ( \overline{s} ) p ( x \vert \overline{s} )} ,$$
and
q(s|x) is:
$$q ( s \vert x ) = \frac{q ( s ) p ( x \vert s )}{q ( s ) p ( x \vert s ) + q ( \overline{s} ) p ( x \vert \overline{s} )} , or \\ q ( s \vert x ) ) = \frac{p ( s \vert x ) q ( s ) p ( \overline{s} )}{p ( s \vert x ) q ( s ) p ( \overline{s} ) + ( 1 - p ( s \vert x ) ) q ( \overline{s} ) p ( s )} .$$

23. An apparatus comprising:
one or more computer processors; and
a non-transitory computer-readable storage medium comprising instructions, that when executed, control the one or more computer processors to be configured for:
training a predictive model configured to predict a probability that advertisement (ad) impressions belong to a segment that is being targeted, the ad impressions provided during sending of videos to users;
determining a first threshold in which the probability predicted from the predictive model is compared to determine whether ad impressions belong to the segment;
determining a distribution probability used in the training of the predictive model, the distribution probability being determined based on a characteristic for ad impressions on a site;
determining a changed distribution probability for the site; and
determining a second threshold in which the probability predicted from the predictive model is compared to determine whether ad impressions belong to the segment.
